(19) United States
(12) Patent Application Publication
(10) Pub. No.: US 2013/0072211 A1
(43) Pub. Date: Mar. 21, 2013

(54) Method and Equipment of Communication

(71) Applicant: Huawei Technologies Co., Ltd., Shenzhen (CN)

(72) Inventors: Tao Cai, Kista (SE); Georgios Koudouridis, Kista (SE); Johan Johansson, Kungsaengen (SE)

(73) Assignee: HUAWEI TECHNOLOGIES CO., LTD., Shenzhen (CN)

(21) Appl. No.: 13/676,859

(22) Filed: Nov. 14, 2012

Related U.S. Application Data
(63) Continuation of application No. PCT/IB2010/001639, filed on Jul. 2, 2010.
Application No. PCT/IB2010/001639 is a continuation of application No. PCT/SE2010/000136, filed on May 15, 2010.

(51) Int. Cl. H04W 72/04

(52) U.S. Cl. CPC H04W 72/0433
USPC 455/452.1

(57) ABSTRACT

A method of parameter setting of a base station for providing communications services to user equipment in a radio communications network that includes the base station. The method includes determining a parameter value of at least partially distributed control. The determining is initiated upon communication between the base station and an entity of central control.

This application is a continuation of co-pending International Application No. PCT/IB2010/001639, filed Jul. 2, 2010 and International Application No. PCT/SE2010/000136, filed May 15, 2010, both of which applications are incorporated herein by reference.

### TECHNICAL FIELD

The technical field of radio communications provides relevant art of technology for this specification of an invention. This may also be the case for the technical fields of downlink parameter setting, such as downlink transmission power setting, and distributed control.

### BACKGROUND

In a cellular network, the power of downlink transmissions is usually set at a value or value range in order to guarantee coverage and satisfy requirements on quality of service provided to users. A base station power value can usually be set to fit with network deployment or user traffic characteristics. Conventionally, such power value change is centrally controlled where statistics of user performance are collected and analyzed in a central network management entity.

Annealed Gibbs Sampling comprises two components. Simulated Annealing and Gibbs Sampling. Simulated Annealing is a probabilistic mechanism to simulate a physical process of annealing where a substance is cooled gradually to reach a minimum-energy state. A possibly non-improving move can be made to avoid being stuck in local minimum. The probability of such a move is calculated with Gibbs Sampling. Gibbs Sampling theory provides one example on how to generate samples from a joint probability distribution of multiple variables, when the joint distribution is not explicitly known but the conditional distribution of each variable is known.

### SUMMARY OF THE INVENTION

A problem with a centralized power setting is its high requirements on performance and processing capacity of a central entity, as it needs consider many network performance objectives and make resource control decisions based on collected statistics from a large quantity of network entities. This further makes it less useful to adapt to, e.g., local, changes of traffic distribution or (sub-)network topology.

An example merit of a strictly distributed power setting is that it provides an inherent adaptation capability. A problem with a strictly distributed power setting, though, is the time needed for the system to converge and reach a stable operating state can be very long.

Prior art technology as known to the inventors does not provide a means of both timely and computational efficient providing a (sub-)network power setting of an operating state.

Consequently, it is an objective of embodiments of the invention to provide power setting, utilizing UE (User Equipment) measurements and the information exchange between neighbouring base stations.

Example embodiments of the invention can control convergence speed of distributed parameter setting.

Other embodiments of the invention can control when to start or stop an iterative parameter setting process without involving into data collection or exceeding central processing capacity.

Further, another embodiment of the invention can monitor traffic load, various performance objectives or change of operator parameter setting policy.

Also, another embodiment of the invention can provide a (sub-)network capable of adapting parameter setting in relation to, e.g., traffic distribution.

Another embodiment of the invention can achieve better cell edge user throughput through distributed or recursive power (re-)setting.

Additionally, and embodiment of the invention can communicate messages carrying information relevant for base station parameter setting across a base-station to base-station interface.

Yet another embodiment of the invention can communicate messages carrying information relevant for control of distributed parameter setting across an interface between a central-entity and one or more base-stations on a low-frequency basis.

According to an aspect of the invention a means of central control of distributed parameter setting is provided.

The invention provides method and equipment of a central coordination entity collaborating with base stations on measurements or computation functions distributed in the base stations as described in detail below.

An example parameter for setting in accordance with the invention is downlink transmission power. An example control parameter for this purpose is cell edge user throughput or derivative thereof.

### BRIEF DESCRIPTION OF THE DRAWINGS

FIG. 1 illustrates an example (sub-)network of a “group” of base stations of a targeted system in accordance with the invention;

FIG. 2 plots an example step function describing the mapping between channel quality and the expected throughput in accordance with the invention;

FIG. 3 shows a flow chart illustrating example processing in accordance with the invention;

FIG. 4 schematically illustrates network equipment according to an embodiment of the invention;

FIG. 5 schematically illustrates in block diagram example processing circuitry of determining input parameter and/or monitoring of an event trigger in accordance with the invention;

FIG. 6 schematically illustrates a system embodied in accordance with the invention.

### DETAILED DESCRIPTION OF ILLUSTRATIVE EMBODIMENTS

The work leading to this invention has received funding from the European Community's Seventh Framework Program (FP7) under grant agreement n^{o} 9302054.

Hybrid distributed and central parameter control is disclosed. An example embodiment provides processing and communications between entities as required for example hybrid distributed sending power setting according to simulated Gibbs annealing applying a probability distribution of Gibbs sampling as an example probability distribution.

The targeted system is a (sub-)network of a “group” of base stations (and UEs served by the base stations) within the same geographical area where coverage of one base station and user service throughput served by this base station are impacted by its neighboring base stations, as shown by example in FIG. 1 (where base stations (14), (15) serving UEs (18), (19) are neighbors of a base station (16) whose radio waves not only covers its served cell (13) but also other cells (14), (15). In the figure, respective base stations (14-16) are illustrated in the center of a single served cell (11-13). This is only an example for the purpose of illustration and to facilitate reading and does not exclude that base stations, e.g., are put in a corner of a cell (sector cell) or cover more than one cell. When downlink transmission power of base stations are changed, the received power from base stations to UEs and UEs experienced Signal to Interference ratio, SIR, will be changed. This in turn leads to change of base stations coverage and user service throughput.

In accordance with the invention, the sum of potential delay of all the UEs in the network is minimized in order to maximize coverage and user service throughput. The potential delay is defined as the inverse of the long-term throughput, which can be derived from a UE's experienced Signal to Interference ratio (SIR). SIR for UE k (18), which is connected to base station i (15), on the downlink is determined by its received power from the serving base station i (15) and the interfering neighboring base stations (e.g., base station j (14)).

$${SIR}_{k} = \frac{{g}_{i} {P}_{i}}{{\sum }_{j \neq i} {g}_{j} {P}_{j} + {N}_{0}} , \qquad ( eq . 1 )$$

where Pi, Pj are the downlink transmission power for base station i (15) and base station j, respectively. gi and gj are the path gains from base station i and base station j (14) to UE k (18). N0 is the thermal noise in the network; a potential throughput can be expected for UE k (18), as shown in formula (eq. 2). Function Γ is a step function describing the mapping between channel quality and the expected throughput.

Thrptₖ=Γ(SIRₖ) (eq. 2)

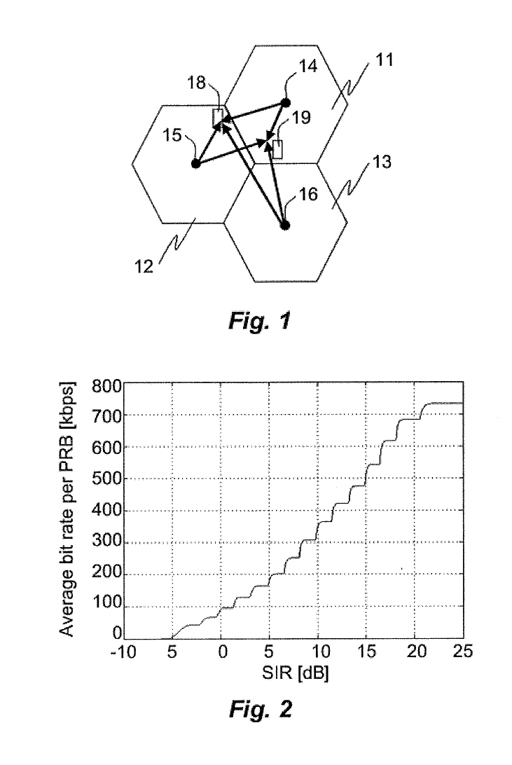

It could be obtained from link level simulation and illustrated as in FIG. 2 plotting average bit rate per PRB (Physical Resource Block) versus SIR (Signal to Interference Ratio). Long Term Delay D is the inverse of the potential throughput, Thrpt,

$${D}_{k} = \frac{1}{{Thrpt}_{k}} .$$

For base station i, the sum of all its connected UE's potential delay can be denoted as

$${D}_{i} = {\sum }_{k ∈ i} \frac{1}{Γ ( {SIR}_{k} )} , \qquad ( eq . 3 )$$

where the summation includes user equipment served by cell i. In a sense, all cells contributing to interference (and thereby to delay) of UEs of cell k are interfering neighbor cells (or rather the base stations serving those cells are interfering base stations).

For a group of base stations, the target of is to minimize overall potential delay for UEs in all cells of consideration (one cell is the coverage area of one base station, this term will be used in the following texts, such as cell edge users; cell also collectively means all users served by one base station as in cell throughput), i.e., to minimize D as denoted in formula (eq. 4)

$$D = {\sum }_{i} {D}_{i} . \qquad ( eq . 4 )$$

To take into account the impact of interference from neighboring base stations, for perfection the power adaptation need be performed jointly.

A local “energy” function is defined as

$${E}_{i} = {D}_{i} + {\sum }_{j} ( {D}_{i} + {D}_{j} ) , \qquad ( eq . 5 )$$

where base station j is a neighboring base station of base station i and all neighboring base stations of consideration are preferably included in the summation.

The total delay in formula (eq. 5) is preferably minimized applying Annealed Gibbs Sampling on a Gibbs Distribution of which conditional probabilities are derived from the local energy function as in formula (eq. 6). Though other distributions would be of relevance as well and are within the scope of the invention. E.g., the base in eq. 6 below need not be the exponential function, but could be virtually any real or natural number.

Considering base station i, the state is its downlink transmission power value Pi, which is taken from a discrete set S, and its neighboring base stations are denoted as in state Ni. The probability that base station i transmits with power value of Pi can be determined from

$${π}_{i} ( {P}_{i} ) = \frac{{e}^{- \frac{Ei ( Ni , {P}_{i} )}{T}}}{{\sum }_{{P}_{i} ∈ S} {e}^{- \frac{Ei ( Ni , {P}_{i} )}{T}}} , {P}_{i} ∈ S . \qquad ( eq . 6 )$$

In eq. 6, T is a “temperature” parameter used to reflect the cooling of this annealing process, which depends on SP, a scaling parameter to control the cooling speed, and N, the number of performed Gibbs Sampling cycles which is related to the elapsed time since the iterative process was initiated/started:

$$T = \frac{1}{ln ( N * SP + 1 )} . \qquad ( eq . 7 )$$

In this scheme, for each Gibbs Sampling cycle, every base station takes turn to sample a power value according to probability it and tunes to that power value. The calculation of probability π in each base station depends on the measurement assistance from UEs and information transferred from its neighboring base stations, including the current power value of one base station and its power value range. According to formulas (eq. 3) and (eq. 5), Di and Dj can be determined, using the mapping from channel quality to expected throughput function, based on the RSRP (Reference Signal Received Power) and/or RSRQ (Reference Signal Received Quality) measurements reported by UEs served by base station i and base station j, where the reference signal is a pilot signal. Base station j then is able to transfer Dj through also information exchange interface to base station i such that base station i can calculate Ei(Ni, Pi).

For the denominator part in formula (eq. 6) to be calculated, base station i needs to know its own long term delay value as well as its neighboring base station's, assuming base station i would take every possible power values other than the current power value, given that all its neighboring base stations take the same power as the current value in the numerator part, i.e., Ni.

UE m in cell j is requested to make measurements on its serving base station j and also on its neighboring base stations, e.g., base station i. The measurements include RSRP and RSRQ from both base station j (14) and base station i (15). For formula in eq. 8, pathgain from UE m to base station i (and base station j) (gj, gi) and received power from other base station l (16) plus noise can be calculated with the knowledge of received power and the transmission power from base station i, which is sent to base station j by base station i. In this way, base station j can calculate a long term delay value, assuming base station i would take all possible transmission power value other than the current one, and then transfer all possible long term delay values back to base station i,

$${SIR}_{m} = \frac{{g}_{j} {P}_{j}}{{g}_{i} {P}_{i} + {\sum }_{i \neq j , i} {g}_{i} {P}_{i} + {N}_{0}} . \qquad ( eq . 7 )$$

After that, base station i typically calculates probability Γ, samples a power value according to probability Γ and tunes to that power value.

An example implementation will be described now.

Hybrid architecture is used in this scheme. One central entity takes record on each cells status (long term transmission delay and power value of the base station) and decides when to start/stop a Gibbs Sampling iterative process.

Especially, the speed of convergence of the recursive processing can be changed/controlled by the central entity. The central entity can start a fast/aggressive recursion/convergence for quick change of the network status. The central entity can also start a slow process to achieve a result closer to an optimum.

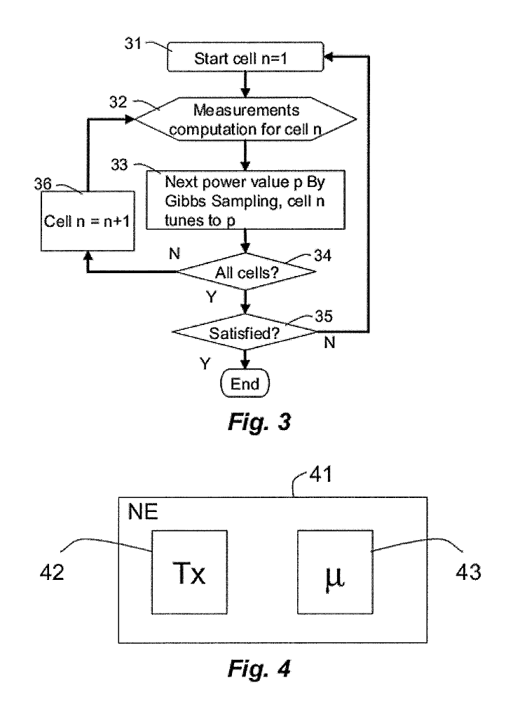

The example recursive/iterative process comprises a number of Gibbs Sampling cycles. For each Gibbs Sampling cycle, the measurement and calculation are done in a distributed manner but coordinated by a central entity. The iteration/recursion can be triggered by a UE experiencing unsatisfactory service or the central entity senses the network performance is deteriorating below a threshold. The triggering and termination of the process is to be decided by central entity according to pre-set conditions upon collection/receipt of relevant data. Example processing is illustrated in FIG. 3 and is briefly explained as follows.

1) Base station i initiates a measurement request to UE that is connected to this base station (31). Preferably at the same time, a request is sent to its neighboring base stations for reporting back of their long term transmission delay values.

2) The neighboring base stations j, after receiving reporting request from base station i, initiates (32) a measurement request to its own connected UEs and assigns base station i to be measured as its neighboring base station. UEs are required to measure, e.g., RSRQ and/or RSRP from base station j and neighboring base station i.

3) Base station j then calculates its long term transmission delay values, assuming base station i would have taken transmission power values from power value set S and transfers those values back to base station i through inter base station interface.

4) Base station i, after collecting long term transmission delay values from its neighboring base stations, calculates a state probability and takes a sampling according to this probability law and uses the sample as its new transmission power value (33).

5) Next base station (36) repeats step 1-4 and changes its transmission power accordingly.

6) After a Gibbs Sampling cycle (34), (35), base stations involved in the process report their current power value and long term transmission delay to central coordinating entity.

7) The central coordinating entity decides (35) whether to stop or continue the process by comparing long term transmission delays of the cells involved with pre-set threshold, e.g., the initial long term transmission delays minus an expected gain from the processing.

In this implementation, the measurement is done utilizing measurement request and reporting mechanism which are similar to standard measurement procedure in e.g., E-UTRA (Evolved Universal Terrestrial Radio Access) network.

The computation load for each base station in step 3 is small. Also the central coordinating entity does not need to execute heavy calculation either but only needs to maintain a list of power value for each base station and observed cell long term transmission delay. In a preferred embodiment, one or more criteria for starting/stopping the iterative process, e.g., relying upon Gibbs sampling, is set beforehand by, e.g., a network operator.

An advantage of this method is the throughput for especially the cell edge users being considered in a weighted manner and thereby may be improved. This is an inherent property of determination of the delay parameter including various users as illustrated in equation eq. 3. The optimization of edge user throughput is done gradually towards a converged state. With the coordination of the central entity, this optimization process can be stopped within any time period when the expected gain on the edge user throughput has been reached.

FIG. 4 schematically illustrates network equipment (41) according to an embodiment of the invention, comprising communication circuitry (42) and processing circuitry (43). Example network equipment is base station equipment and central entity equipment.

In example base station equipment (41), e.g., reported UE measurements are communicated (42) to a central entity for inclusion in processing of the central control of hybrid distributed parameter setting. The base station receives communications (42) from central entity, such as start stop triggers/scaling parameter or other indicator/parameter is mentioned elsewhere in this specification, and provide the relevant extracted information for further processing in the processing circuitry (43) or picking/generating a (pseudo-)random parameter sample (43) according to a preferred probability distribution, such as in accordance with Gibbs sampling, and preferably communicating (42) the picked/generated sample to one or more other entities. The base stations also monitor experience quality and reports the experience quality to a central entity for further processing of central control of the hybrid distributed control processing.

In example central entity equipment (41), processing equipment (43) determines a scaling factor parameter, e.g., for controlling the adaptation/convergence speed of recursive annealing processing or potential residual error or for combining of experienced delay or delay representation or one or more parameters on which such representation is based. Also depending on e.g., operator input, the central entity will provide (42) control signaling to a corresponding number of base stations for to be included in parameter (re-)setting and/or trigger signaling for starting/stopping recursive processing for (re-)setting of such parameter. According to an embodiment of the invention relevant input of base station equipment identified level of satisfaction (or lack of satisfaction) generates an input required to be detected and/or processed by the communications circuitry (42) and received data or level of one base station to be processed and balanced in the processing circuitry (43) to corresponding level parameters received from other base stations.

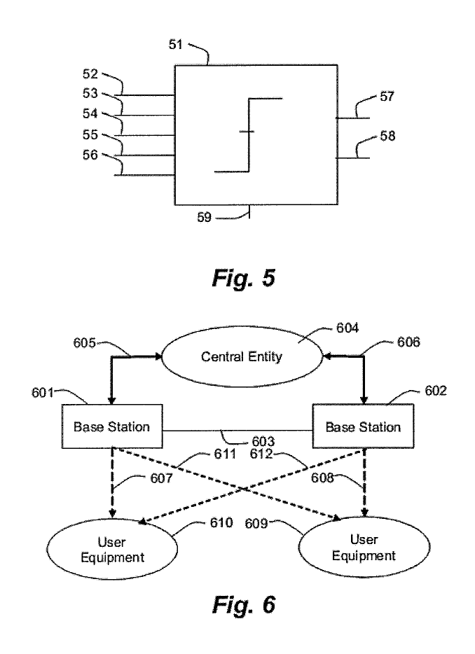

FIG. 5 schematically illustrates in block diagram example processing circuitry of determining input parameter and/or monitoring of an event trigger, which may be incorporated in a single signaling/communication message or information field, depending on number of bits allocated. The processing circuitry, represented in the figure by a threshold device (51) but preferably comprising timing circuitry and processing circuitry for processing of stored instruct ions, receives one or more inputs (52)-(56). The processing circuitry outputs one or more outputs (57), (58) comprising parameter value or setting/resetting of an indicator of, e.g., base station initiating another parameter (re-)setting cycle of determining of an explicit parameter value, such as transmission power value. Depending on whether the processing is event based (e.g., triggering of initiating recursive Gibbs Sampling according to an annealing criterion) or polled, the processing preferably includes relevant timing input/output (59).

FIG. 6 schematically illustrates a system embodied in accordance with the invention. Base stations (601), (602) comprising communications circuitry for transmission preferably at least one of a transmit parameter, e.g., base station transmit power; and a receive (607), (608) parameter, e.g., reference signal received power, reference signal received quality or other parameter depending on a parameter setting for distributed control, such as base station transmit power, to other one or more base stations (602), (601) or a central entity (604). Transmission to one or more other base stations preferably occurs over a base-station—base-station interface (603), such as an X2 interface, though relaying across another entity, e.g., a central entity (604), is an option. User equipment report (609, 610) measurement results to the base station it is serving. Such measurement report preferably includes Signal to Interference Ratio or other measures with impacting on (sub-)network performance.

Received signals from other base stations (611), (612) or interfering user equipment served by other cells are examples of sources of such interference. The base stations 10 are preferably equipped for reporting (605), (606) to a central entity performance requirements or specifications not being met according to, e.g., such measurements.

Similarly the central entity (604) is preferably equipped for receiving and processing the communications received and for communicating messages or filed elements of messages to the base stations, comprising, e.g., trigger bits or step size bits for the 15 recursive distributed processing in the base stations in accordance with corresponding central control. The central entity and base stations communicate (605), (606) preferably for initiating a parameter (re-) setting recursion process, for which both types of equipment are equipped with corresponding processing and communication circuitry.

In this description, certain acronyms and concepts widely adopted within the technical field have been applied in order to facilitate understanding. The invention is not limited to units or devices due to being provided particular names or labels. It applies to all methods and devices operating correspondingly. This also holds in relation to the various systems that the acronyms might be associated with.

The invention may be of relevance in any communication network where there exist radio links between transmitters and one or more receivers and where the quality of radio transmission of the link is impacted by interfering transmitter. The example implementation of this invention is described with the optimization of downlink transmission power. Other parameters, besides the downlink transmission power, can be optimization with the same method, in order to achieve a preferred performance objective.

While the invention has been described in connection with specific embodiments thereof, it will be understood that it is capable of combining the various embodiments, or features thereof, as well as of further modifications. This specification is in-tended to cover any variations, uses, adaptations or implementations of the invention; not excluding software enabled units and devices, processing in different sequential order where non-critical, or mutually non-exclusive combinations of features or embodiments; within the scope of subsequent claims following, in general, the principles of the invention as would be obvious to a person skilled in the art to which the invention pertains.

What is claimed is:

1. A method of parameter setting of a base station for providing communications services to user equipment in a radio communications network that comprises the base station, the method comprising determining a parameter value of at least partially distributed control, the determining being initiated upon communication between the base station and an entity of central control.

2. The method according to claim 1, wherein a transmit parameter value is determined in the base station based upon input of a parameter value of central control.

3. The method according to claim 1, wherein a transmit parameter value is determined on the basis of at least one receive parameter value of a user equipment device.

4. The method according to claim 1, wherein a transmit parameter value is determined upon input of central control of a start or stop indicator.

5. The method according to claim 1, wherein the determining comprises:
collecting a receive parameter value of at least one user equipment device;
determining a criterion of parameter setting of the base station based upon the collected value from the at least one user equipment device, the criterion forming a basis of a state probability distribution;
determining a state probability according to the state probability distribution; and
conditionally determining a transmit parameter value based upon the state probability distribution by taking a pseudo-random value according to the state probability distribution.

6. The method according to claim 1, wherein a transmit parameter value is determined based upon received at least one receive parameter value.

7. The method according to claim 6, wherein the transmit parameter value is determined on the basis of at least one receive parameter value of a user equipment device.

8. The method according to claim 7, wherein the at least one receive parameter value of a user equipment is represented in the communication between the base station and an entity of central control.

9. The method according to claim 1, wherein the parameter value of central control comprises at least one of
a scaling factor parameter;
a weighting factor parameter; and
an adaptation speed parameter.

10. The method according to claim 1, wherein the parameter value is conditionally determined.

11. The method according to claim 10, wherein the condition comprises whether a transmit parameter value has reached a particular threshold value.

12. The method according to claim 11, wherein receive parameters of a plurality of base stations form a basis for the determination of a parameter value of at least partially distributed control.

13. The method according to claim 1, wherein a parameter of central control is determined based upon input of the base station.

14. The method according to claim 13, wherein the parameter of central control is determined based upon input of a plurality of base stations.

15. The method according to claim 1, wherein the parameter value facilitates balancing performance/operating conditions of different user equipment devices.

16. The method according to claim 1, wherein a transmit parameter value is transmission power level.

17. Network equipment for parameter setting of a base station to provide communications services to user equipment of a radio communications network that comprises the base station, the network equipment comprising:
communication circuitry configured to communicate with network equipment; and
processing circuitry configured to determine, as initiated upon communication between the base station and an entity of central control, a parameter associated with a transmit parameter value of at least partially distributed control.

18. The network equipment according to claim 17, wherein the processing circuitry is further configured to determine how many base stations to include in the at least partly distributed control.

19. The network equipment according to claim 17, wherein the processing circuitry is further configured to determine at least one of
a scaling factor parameter;
a weighting factor parameter; and
an adaptation speed parameter.

20. The network equipment according to claim 17, wherein the processing circuitry is further configured to determine when to start/stop parameter setting.

21. The network equipment according to claim 17, wherein the communication circuitry is further configured to communicate a parameter of at least partly distributed control to a number of base stations as determined.

22. The network equipment according to claim 17, wherein the communication circuitry is further configured to communicate at least one of
a scaling factor parameter;
a weighting factor parameter; and
an adaptation speed parameter.

23. The network equipment according to claim 22, comprising
processing circuitry configured to initiate determination of a parameter value in response to at least one receive parameter value; and
communication circuitry configured to communicate the determined parameter value to at least one base station.

24. The network equipment according to claim 17, wherein the communication circuitry is further configured to communicate a message one or more bits indicating when to start/stop the at least partially distributed control.

25. The network equipment according to claim 17, wherein the processing circuitry is further configured to determine a message field element of the at least partially distributed control and wherein the communication circuitry is further configured to communicate the message field element of the at least partially distributed control.

26. The network equipment according to claim 17, wherein the processing circuitry is further configured to compare a receive parameter value to a threshold parameter value and wherein the communication circuitry is further configured to communicate the receive parameter value at least when the received parameter value is less than the threshold parameter value.

27. The network equipment according to claim 17, wherein the processing circuitry is further configured to compare a transmit parameter value to a threshold parameter value and wherein the communication circuitry is further configured to communicate conditionally upon the transmit parameter value being greater than the threshold parameter value.

28. The network equipment according to claim 17, wherein the communication circuitry is further configured to communicate a transmit parameter value between base stations.

29. A radio communications system comprising:
a plurality of base stations configured to provide communications services to user equipment of the radio communications system, the base stations comprising communication circuitry configured to transmit a receive/transmit parameter value; and
an entity of central control that comprises communication circuitry configured to transmit at least one of a start/stop iteration indicator and/or a step size indicator or a convergence rate indicator.

30. The system according to claim 29, wherein the receive/transmit parameter is at least one of
signal power;
Interference level;
Signal to Interference Ratio;
receive signal quality;
system delay; and
system throughput.
